(19) United States
(12) Patent Application Publication
(10) Pub. No.: US 2007/0234785 A1
(43) Pub. Date: Oct. 11, 2007

(54) System and method for using a flexible membrane for controlling fluid flow in a microfluidic circuit

(76) Inventors: Timothy Beerling, San Francisco, CA (US); Reid Brennen, San Francisco, CA (US); Hongfeng Yin, Cupertino, CA (US); Ronald Shane Fazzio, Loveland, CO (US); Kevin Killeen, Woodside, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/394,309

(22) Filed: Mar. 30, 2006

(51) Int. Cl. G01N 30/38

(52) U.S. Cl. 73/61.56; 137/561 R; 251/335.2

(57) ABSTRACT

A system for controlling fluid flow in a microfluidic circuit located in a liquid chromatograph includes at least one microfluidic channel and a flexible membrane adjacent the at least one microfluidic channel, wherein when actuated, the flexible membrane deflects into the microfluidic channel, thus impeding fluid flow in the microfluidic channel.

### BACKGROUND

A liquid chromatograph is one example of a device in which it is desirable to control the flow of one or more fluids using a microfluidic circuit. In liquid chromatography, a sample liquid is passed through what is referred to as a “packed column.” The packed column contains material that is referred to as the “stationary phase.” As the liquid passes through the packed column, the stationary phase impedes the movement of the liquid such that different materials that are contained in the liquid sample pass through the packed column at different rates and elute from the packed column at different times. The material eluting from the packed column can be identified by measuring the elution time of each material. The output of the packed column is typically directed to an outlet channel for injection into a detector.

It is typically desirable to maintain a constant flow of fluid to the outlet channel of the column. The flow rate through the column depends on the pressure gradient across the column and on the nature of the sample fluid. For example, the viscosity of the sample fluid may change during the course of a single analysis. This causes the fluidic impedance of the column and possibly other parts of the fluidic circuit to change. The change in fluidic impedance causes an undesirable change in the flow rate through the outlet channel of the column.

### SUMMARY OF THE INVENTION

In accordance with the invention, a system for controlling fluid flow in a microfluidic circuit comprises at least one microfluidic channel located in a liquid chromatograph and a flexible membrane adjacent the at least one microfluidic channel, wherein, when actuated, the flexible membrane deflects into the microfluidic channel. The flexible membrane impedes fluid flow in the microfluidic channel. The amount of the deflection of the flexible membrane can be controlled so that the flow in the microfluidic channel can be modulated.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an electrical circuit representation of a fluidic circuit.

FIG. 2A is a schematic diagram illustrating a fluidic circuit.

FIG. 2B is a schematic diagram illustrating the fluidic circuit of FIG. 2A in which fluid flow is controlled by the membrane switch elements.

FIG. 3A is a schematic diagram illustrating a cross-sectional view of an exemplary membrane switch of FIG. 2A and FIG. 2B.

FIG. 3B is a schematic diagram illustrating a cross-sectional view of the membrane switch of FIG. 3A after actuation of the membrane.

FIG. 4A is a detailed schematic diagram illustrating a cross-sectional view of the fluid cavity of FIG. 2A and FIG. 2B including a membrane switch element.

FIG. 4B is a schematic diagram illustrating a cross-sectional view of the fluid cavity of FIG. 4A after actuation of the membrane.

FIG. 5 is a flowchart describing a method for controlling fluid flow in a microfluidic circuit.

FIG. 6A is a schematic diagram illustrating a membrane switch assembly.

FIG. 6B is a schematic diagram illustrating the membrane switch assembly of FIG. 6A during actuation.

FIG. 7 is a detailed schematic diagram illustrating a cross-sectional view of an alternative embodiment of the membrane switch element of FIGS. 4A and 4B.

FIG. 8 is a block diagram illustrating a simplified analytical device 100, which is an exemplary device in which one or more membrane switch elements may be implemented.

### DETAILED DESCRIPTION

The system and method for controlling fluid flow employs one or more flexible membranes located in a microfluidic circuit. When actuated, the membrane deflects into a microfluidic channel thus impeding the flow of liquid in the microfluidic channel by at least partially blocking the microfluidic channel. Although described for use in controlling the flow of fluid in a liquid chromatograph, the system and method for using a flexible membrane for controlling fluid flow in a microfluidic circuit can be used to control fluid flow in any microfluidic circuit.

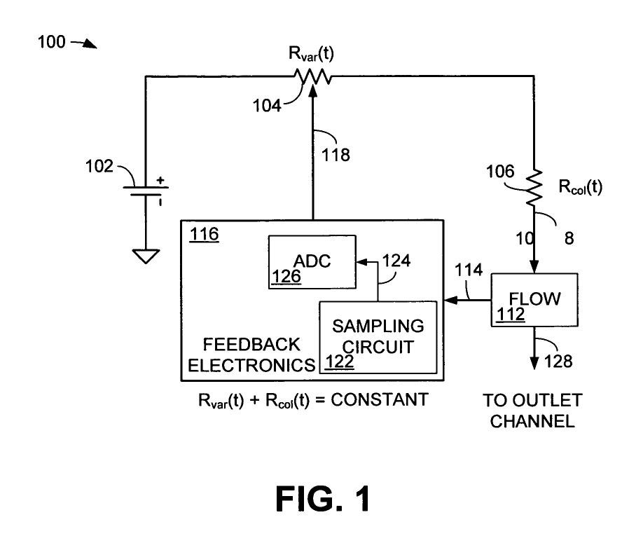

FIG. 1 is a schematic diagram illustrating an electrical circuit representation 100 of a fluidic circuit. The electrical circuit representation comprises a pressure source 102, which is schematically illustrated as a voltage source. The pressure source 102 is coupled to a variable fluidic impedance 104, which is represented as a variable resistance. The variable fluidic impedance 104 can be electrically represented as Rᵥₐᵣ(t). The variable fluidic impedance 104 is coupled to a column 106, which is schematically illustrated as a fixed resistance. In an embodiment, the column 106 could be a packed column used in liquid chromatography. The column 106 can be electrically represented as R_{col}(t), where R is the resistance through the column. The output of the column 106 is coupled to a flow sensor 112. The flow sensor 112 monitors the fluid flow through the column 106 and provides a flow signal to the feedback electronics 116 via connection 114. The output of the flow sensor on connection 128 is directed to, for example, the outlet channel of a liquid chromatograph.

The feedback electronics 116 comprises a sampling circuit 112 that samples the output of the flow sensor 112 on connection 114. The sampling circuit 122 provides an analog signal over connection 124 to an analog-to-digital converter (ADC) 126. The ADC 126 digitizes the sensor signal and provides a digital control signal via connection 118. The control signal on connection 118 controls the variable fluidic impedance 104 so that desired fluid flow and pressure is maintained at the output of the column 106.

In the electrical circuit representation 100, a constant flow across the column 106 can be obtained by varying the flow through the column 106 using the variable impedance 104 such that the total impedance of the system is constant. Similarly, a constant flow through the column 106 can be maintained by varying the pressure provided by the pressure source 102, with the pressure increasing with an increase in the total impedance of the system.

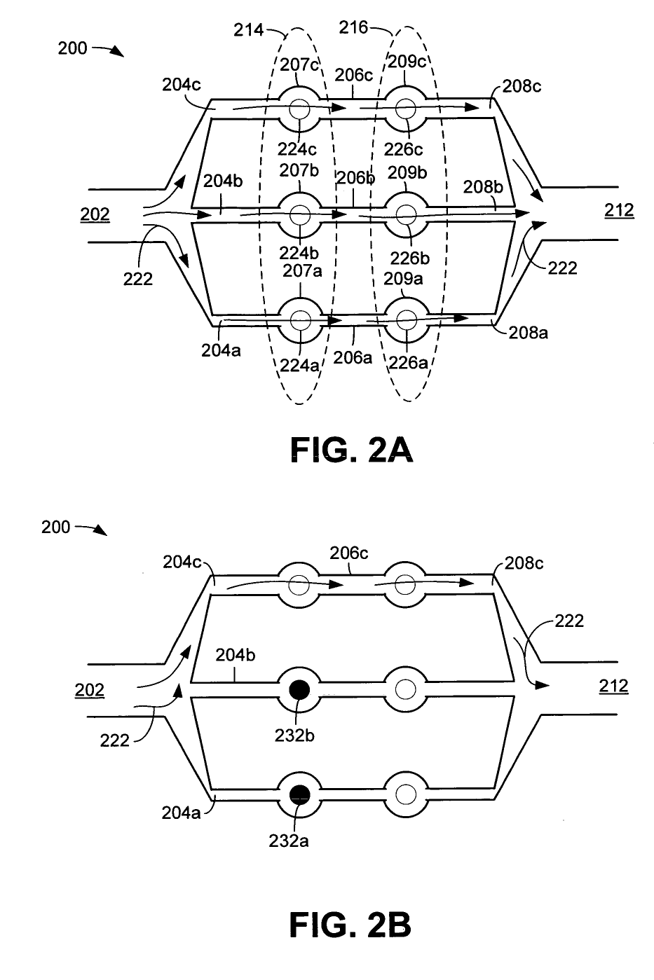

FIG. 2A is a schematic diagram illustrating a fluidic circuit 200. The fluidic circuit 200 is the mechanical analog of the variable fluidic impedance 104 of FIG. 1. The fluidic circuit 200 includes a microfluidic channel 202. In this example, the microfluidic channel 202 branches into three channel portions 204a, 204b and 204c. However, other configurations and numbers of channel portions are possible. Each of the channels 204a, 204b and 204c has a cross-sectional area that is different from each other channel portion. However, this is not necessary for every application. The flow through each channel portion is typically Poiseuille in that the pressure drop in each channel portion is inversely proportional to the fourth power of the hydraulic diameter of each channel.

In this example, the impedance of the channel portion 204b is twice the impedance of the channel portion 204a. Similarly, the impedance of the channel portion 204c is twice the impedance of the channel portion 204b. However, other impedances of the channel portions 204a, 204b and 204c are possible. The example illustrated in FIG. 2A uses three channel portions for simplicity of illustration. When using three channel portions each having different impedances, the equivalent of three bit accuracy is provided for controlling the flow of fluid through the fluidic circuit 200.

The channel portion 204a includes a fluid cavity 207a. The fluid cavity 207a includes a membrane switch element 224a. The fluid cavity 207a is coupled to a channel portion 206a, which is also coupled to another fluid cavity 209a. The fluid cavity 209a includes a membrane switch element 226a. The fluid cavity 209a is coupled to a channel portion 208a. In this example, the channel portions 206a and 208a have a similar cross-sectional area as the channel portion 204a. However, each of the channel portions 204a, 206a and 208a may have different cross-sectional area. The channel portion 208a is coupled to a microfluidic channel 212. The flow of liquid 222 through the channel portions 204a, 206a and 208a and the fluid cavities 207a and 209a is indicated using the arrows.

The channel portion 204b includes a fluid cavity 207b. The fluid cavity 207b includes a membrane switch element 224b. The fluid cavity 207b is coupled to a channel portion 206b, which is also coupled to another fluid cavity 209b. The fluid cavity 209b includes a membrane switch element 226b. The fluid cavity 209b is coupled to a channel portion 208b. In this example, the channel portions 206b and 208b have a similar cross-sectional area as the channel portion 204b. However, each of the channel portions 204b, 206b and 208b may have different cross-sectional area. The channel portion 208b is coupled to a microfluidic channel 212. The flow of liquid 222 through the channel portions 204b, 206b and 208b and the fluid cavities 207b and 209b is indicated using the arrows.

The channel portion 204c includes a fluid cavity 207c. The fluid cavity 207c includes a membrane switch element 224c. The fluid cavity 207c is coupled to a channel portion 206c, which is also coupled to another fluid cavity 209c. The fluid cavity 209c includes a membrane switch element 226c. The fluid cavity 209c is coupled,to a channel portion 208c. In this example, the channel portions 206c and 208c have a similar cross-sectional area as the channel portion 204c. However, each of the channel portions 204c, 206c and 208c may have different cross-sectional area. The channel portion 208c is coupled to a microfluidic channel 212. The flow of liquid 222 through the channel portions 204c, 206c and 208c and the fluid cavities 207c and 209c is indicated using the arrows.

Each of the membrane switch elements 224a, 224b, 224c, 226a, 226b and 226c may comprise one or more flexible membranes that can be actuated to cause the flexible membrane to deflect into the fluid cavity in which it is located. When the flexible membrane is deflected into the fluid cavity, the membrane impedes the flow of liquid through the respective channel portion associated with the fluid cavity. The membrane switch elements 224a, 224b and 224c are primary membrane switch elements 214 and the membrane switch elements 226a, 226b and 226c are secondary membrane switch elements 216. The secondary membrane switch elements 216 may be used if one or more of the primary membrane switch elements 214 fail. By controlling the membrane switch elements 224a, 224b and 224c in each of the fluid cavities 207a, 207b and 207c, the flow of fluid from the microfluidic channel 202 to the microfluidic channel 212 can be precisely controlled. Similarly, by controlling the membrane switch elements 226a, 226b and 226c in each of the fluid cavities 209a, 209b and 209c, the flow of fluid from the microfluidic channel 202 to the microfluidic channel 212 can be precisely controlled.

FIG. 2B is a schematic diagram illustrating the fluidic circuit 200 of FIG. 2A in which fluid flow is controlled by the membrane switch elements. In FIG. 2B, the membrane switch elements 224a and 224b are actuated, causing respective flexible membranes associated with each of the actuated membrane switch elements 224a and 224b to be deflected into the respective cavities 207a and 207b. The presence of the flexible membranes, indicated using reference numerals 232a and 232b, in the respective cavities 207a and 207b, is indicated by the black dot in each cavity 207a and 207b. The flexible membrane 232a controllably impedes the flow of fluid through the channel portion 204a and the flexible membrane 232b controllably impedes the flow of fluid through the channel portion 204b. Accordingly, the fluid 222 is controllably directed through the channel portions 204c, 206c and 208c into the microfluidic channel 212. Typically, due to cavity shape and membrane characteristics, the flexible membrane will not completely block the respective fluid cavity. Further, the pressure drop and the associated fluid impedance modulation provided by a single membrane switch element is limited. A number of membrane switch elements staged in series are typically used to provide a wide range of pressure control and associated fluid impedance modulation.

In one embodiment, the membrane switch elements are rapidly cycled on and off, at a frequency of, for example, many kilohertz (kHz) or greater. The time period for cycling the membrane switch elements is shorter than the “time constant” of the fluidic circuit. The time constant of the fluidic circuit 200 will typically be at least an order of magnitude longer than 1/frequency, where 1/frequency is the time period for cycling the membrane switch elements. In comparing the fluidic network to an electrical network, the fluidic circuit 200 has the equivalent of electrical capacitance, resistance and inductance, which affects the time constant of the circuit. By varying the duty cycle of the membrane switch elements, and therefore the deflection of the flexible membrane into each respective fluid cavity, it is possible to create a controllable average flow through the circuit 200. The averaging effect is because the fluidic circuit cannot respond at the same frequency at which the flexible membranes are deflected into the fluid cavities. This concept is analogous to pulse width modulation (PWM) in an electronic circuit. Using liquid chromatography as an example, the feedback electronics 116 (FIG. 1) monitors the flow through the column 106 (FIG. 1) and modifies the duty cycle of the membrane switch elements of FIGS. 2A and 2B to obtain the desired flow through the fluidic circuit 200.

In another example, the membrane switch elements may be placed in series in a microfluidic channel and activated quasi-statically. Depending on the behavior of the flow through a partially blocked channel, a number of membrane switch elements may be located in series, with each membrane switch element having one or more flexible membranes possibly having a different combination of modulus of elasticity and thickness. In this example, quasi-static activation of the membrane switch elements refers to a switching frequency that allows the fluidic circuit 200 to settle into a steady-state operation between switching events.

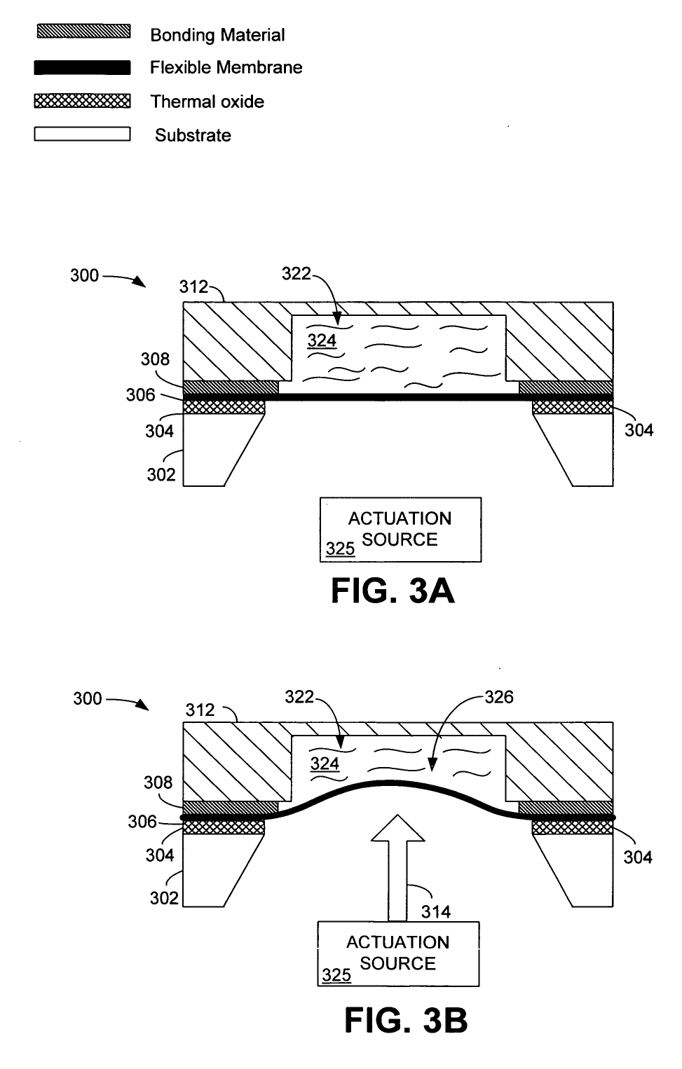

FIG. 3A is a schematic diagram illustrating a cross-sectional view of an exemplary membrane switch of FIG. 2A and FIG. 2B. However, the cross-sectional view of FIG. 3A is representative of any of the fluid cavities of FIG. 2A and FIG. 2B. The cross-sectional view of FIG. 3A is intended to show the basic elements of the fluid cavity of FIG. 2A and FIG. 2B and the membrane switch element 300. A layer 304 of a thermal oxide is located over a substrate 302. The substrate 302 can be, for example, glass, silicon carbide (SiC), or sapphire. In one embodiment, the layer 304 comprises silicon dioxide (SiO₂). However, other material can be used for the layer 306. The substrate 302 can be silicon, or another substrate material.

A flexible membrane 306 formed from a material having a low modulus of elasticity is located over the thermal oxide layer 304. The flexible membrane 306 can be formed from a material such as, for example, a photoimagible polymer such as polyimide or an epoxy-based photoresist material, such as SU-8, which is available from MicroChem Corporation of Newton, Mass. A typical thickness for the flexible membrane 306 ranges from, for example, a few micrometers (μm) to tens of micrometers. Portions of the substrate 302 and the thermal oxide 304 are removed under the membrane 306. A layer of bonding material 308 is applied over the membrane 306 to bond a cap 312 in place over the membrane 306. In an embodiment, the cap 312 can be a glass material, such as Pyrex. Alternatively, the bonding material may be applied to both the membrane 306 and the cap 312 which are then placed together. In an exemplary embodiment, the bonding material can be gold thermocompression bonding, gold-silicon eutectic bonding, gold-indium bonding, glass frit bonding, anodic bonding, in which case the bonding material includes a layer of amorphous silicon applied to the cap 312, or another bonding technique that is known in the art. The cap 312 and the surface of the membrane 306 form a microfluidic cavity 322 that contains a liquid 324. The liquid 324 can be any liquid. In the case of liquid chromatography, the liquid 324 can be a mixture of water and a solvent, such as acetonitrile. In this example, the flow of the liquid 324 is into or out of the plane of the page.

An actuation source 325 is located below the membrane 306. In one example, the actuation source can be a manifold coupled to a pressure source that directs air, a liquid, or another fluid toward the membrane 306. A control circuit is omitted from FIG. 3A for simplicity. However, a control circuit, such as the feedback electronics 116 (FIG. 1) may control the operation of the actuation source 325. The pressure required to maintain “zero deflection” of the membrane 306 depends on the pressure exerted on the membrane 306 by the fluid 324 in the fluid cavity 322. In addition, the pressure required to maintain “zero deflection” of the membrane 306 also depends on where this variable impedance device, embodied as the membrane switch element 300, is placed in the fluidic network. For example, the closer that the membrane switch element 300 is located to the pressure source 102 (FIG. 1) the more pressure is likely to be exerted on the side of the membrane 306 that is in contact with the fluid 324. Therefore, a higher actuation pressure will be exerted by the actuation source 325 to achieve the same deflection than if the membrane is located farther from the pressure source 102.

FIG. 3B is a schematic diagram illustrating a cross-sectional view of the membrane switch of FIG. 3A after actuation of the membrane. As shown in FIG. 3B, in this example, air pressure, indicated using reference numeral 314, from the actuation source 325 causes the membrane 306 to deflect into the microfluidic cavity 322. The membrane 306 enters the microfluidic cavity 322 and impedes the flow of fluid 324. The restriction of the flow of the fluid 324 may be partial to almost complete. The thickness and the composition of the material of the membrane 306, the amount of pressure exerted by the liquid 324 on the liquid side of the membrane 306, and the amount of pressure exerted by the actuation source 325 determine the extent to which the membrane 306 deflects into the microfluidic cavity 322.

In an alternative embodiment, the membrane 306 could be actuated electrostatically, in which electrodes are located in the vicinity of the membrane. Such an embodiment will be described below.

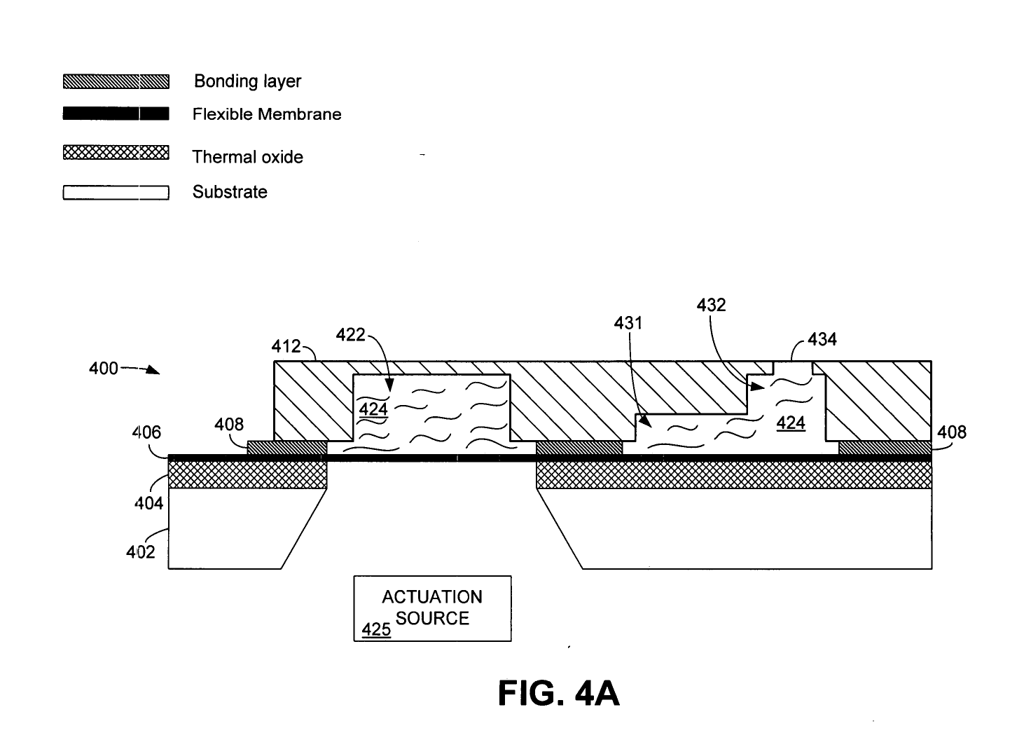

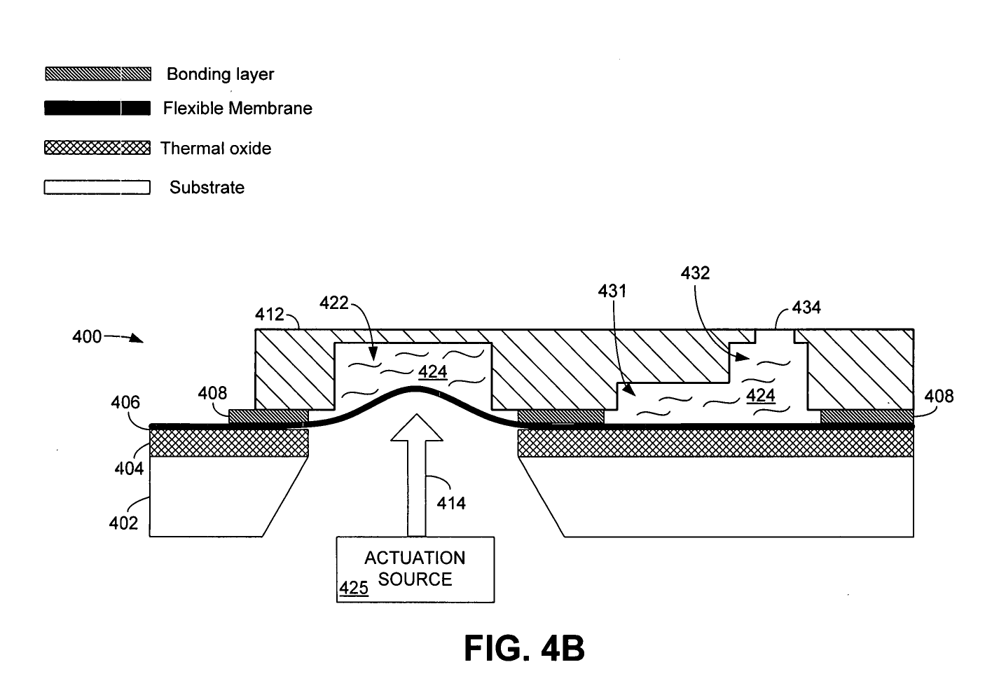

FIG. 4A is a detailed schematic diagram illustrating a cross-sectional view of the fluid cavity 207a of FIG. 2A and FIG. 2B including a membrane switch element 400. A silicon substrate 402 is provided over which a thermal oxide layer 404 is formed. However, other material s may be used for the substrate 402. The layer 404 is similar to the layer 304 described above.

A flexible membrane 406 formed from a material having a low modulus of elasticity is located over the thermal oxide layer 404. The flexible membrane 406 is similar to the flexible membrane 306 described above. Portions of the substrate 402 and the thermal oxide 404 are removed under the membrane 406. A layer of bonding material 408 is applied over the membrane 406 to bond a cap 412 in place over the membrane 406. The cap 412 and the surface of the membrane 406 form a microfluidic cavity 422 that contains a liquid 424. The liquid 424 can be any liquid. In the case of liquid chromatography, the liquid 424 can be a mixture of water and a solvent, such as acetonitrile. In this example, the flow of the liquid 424 is into or out of the plane of the page.

An actuation source 425 is located below the membrane 406. In one example, the actuation source can be a manifold coupled to a pressure source that directs air, or another substance, toward the membrane 406. A control circuit is omitted from FIG. 4A for simplicity. However, a control circuit, such as the feedback electronics 116 (FIG. 1) may control the operation of the actuation source 425.

The cap 412 and the membrane 406 also define a shallow channel 431 and a deep channel 432. The shallow channel 431 and the deep channel 432 also contain fluid 424. The shallow channel 431 provides a higher impedance fluid connection, and the deep channel 432 provides a lower impedance fluid connection. The through etch 434 is for the fluidic input and output to and from the switch element 400.

FIG. 4B is a schematic diagram illustrating a cross-sectional view of the fluid cavity of FIG. 4A after actuation of the membrane. As shown in FIG. 4B, in this example, air pressure, indicated using reference numeral 414, from the actuation source 425 causes the membrane 406 to deflect into the microfluidic cavity 422. The membrane 406 enters the microfluidic cavity 422 and impedes the flow of fluid 424. The thickness and the material of the membrane 406 and the amount of pressure exerted by the actuation source 425 determine the extent to which the membrane 406 enters the microfluidic cavity 422.

In an alternative embodiment, the membrane 406 could be actuated electrostatically, in which electrodes are located in the vicinity of the membrane and separated from the liquid by thin layers of dielectric material.

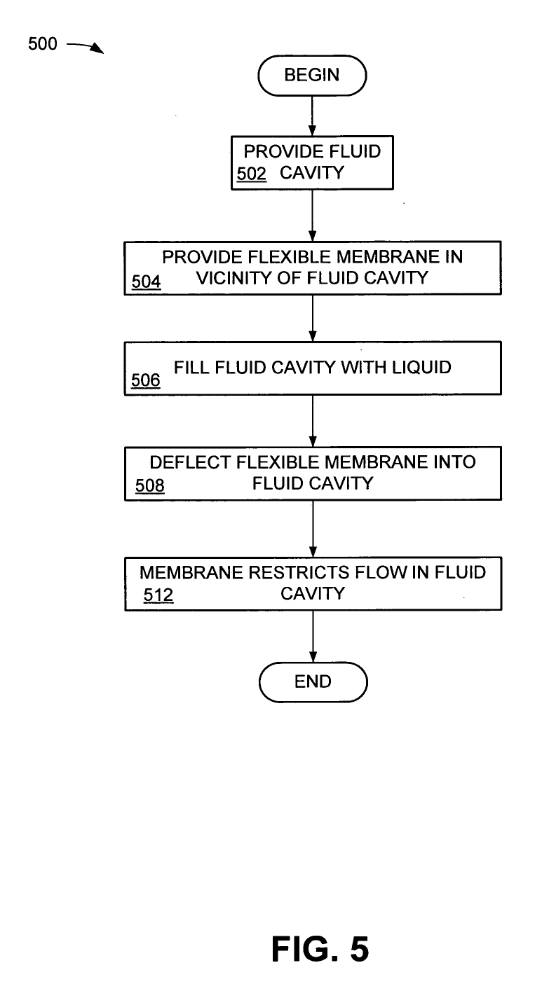

FIG. 5 is a flowchart 500 describing a method for controlling fluid flow in a microfluidic circuit. In block 502 a fluid cavity is provided. In block 504 a flexible membrane is provided in the vicinity of the fluid cavity. In block 506, the fluid cavity is filled with fluid. In block 508, an actuation source is activated to deflect the flexible membrane into the fluid cavity. In block 512, the flexible membrane impedes fluid flow in the fluid cavity.

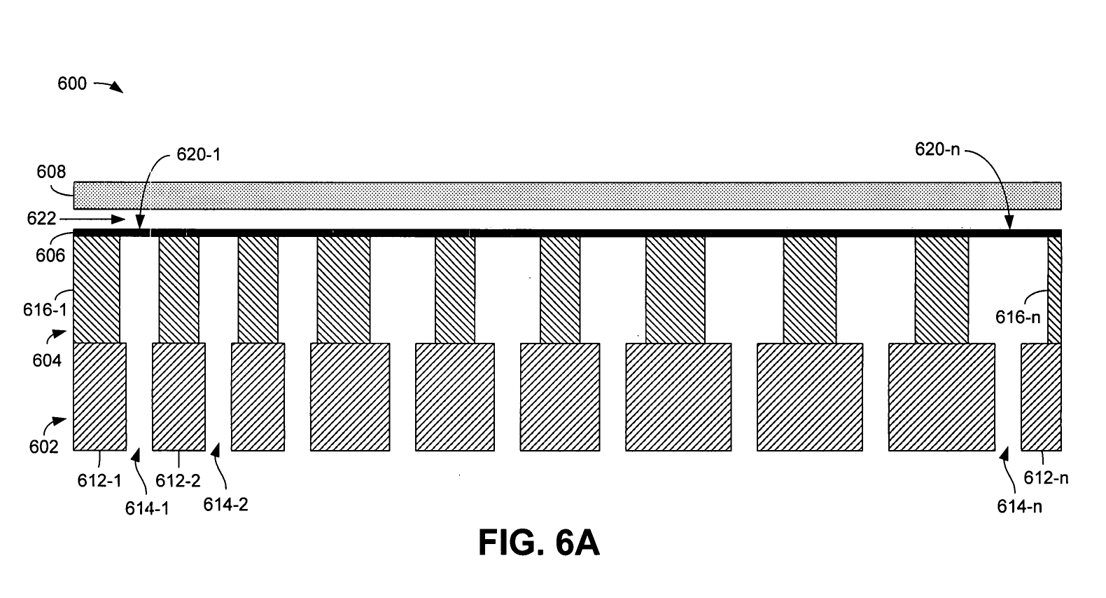

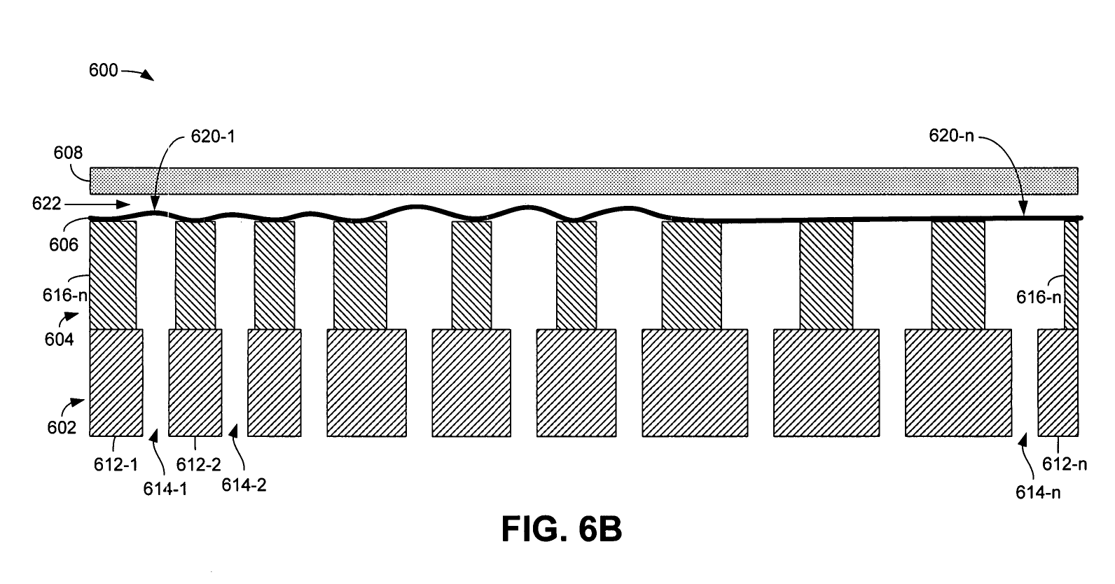

FIG. 6A is a schematic diagram illustrating a membrane switch assembly 600. The membrane switch assembly 600 includes a manifold 602 over which a membrane support structure 604 is located. The manifold 602 includes structural elements 612-1 through 612-n that define passages 614-1 through 614-n. The passages 614-1 through 614-n are configured to allow the passage of an actuating fluid, such as air, inert gas, of another fluid. The membrane support structure 604 includes membrane support elements 616-1 through 616-n.

A flexible membrane 606 is located over the membrane support structure 604. The flexible membrane 606 is similar to the flexible membrane 306 and 406 described above. In this example, the flexible membrane 606 is adhered to the membrane support elements 616-1 through 616-n to define membrane portions 620-1 through 620-n. The membrane portions 620-1 through 620-n each act as an individual membrane. The number of structural elements 612, passages 614, membrane support elements 616 and membrane portions 620 is dependent on the configuration of the membrane switch assembly. In this example, nine membrane portions and corresponding support structure are illustrated. However, other configurations are possible.

Each of the membrane portions 620-1 through 620-n are individually controllable via the respective passages 614-1 through 614-n. Further, in this example, the membrane portions 620-1 through 620-3 are the same size; the membrane portions 620-4 through 620-6 are the same size; and the membrane portions 620-7 through 620-9 are the same size. However, the size and structure of the membrane portions 620 can be determined based on the desired switching characteristics.

A roof 608 is located over the membrane 606 to define a microfluidic channel 622 between them. The support structure for the roof 608 is omitted for simplicity. The direction of fluid flow through the channel is arbitrary. In this example, the flow of fluid through the channel 622 is left to right.

FIG. 6B is a schematic diagram illustrating the membrane switch assembly of FIG. 6A during actuation. In accordance with an embodiment of the invention, pressure delivered through the passages 614-1 through 614-n by an actuation source similar to the actuation source 325 (FIG. 3A) causes the membrane portions 620-1 through 620-n to deflect into the microfluidic channel 622. The deflection of the membrane portions 620 into the microfluidic channel 622 impedes the flow of liquid through the channel. In this example, the membrane portions 620-1 through 620-3 are less compliant than the membrane portions 620-4 through 620-6. Similarly, the membrane portions 620-4 through 620-6 are less compliant than the membrane portions 620-7 through 620-9. The flexibility of the membrane portions 620 is determined by the material from which the membrane 606 is formed, the thickness of the membrane 606 and the size of each membrane portion 620. Further, by individually controlling the pressure supplied to each of the membrane portions 620 via the passages 614, the deflection of each membrane portion 620 can be individually and accurately controlled.

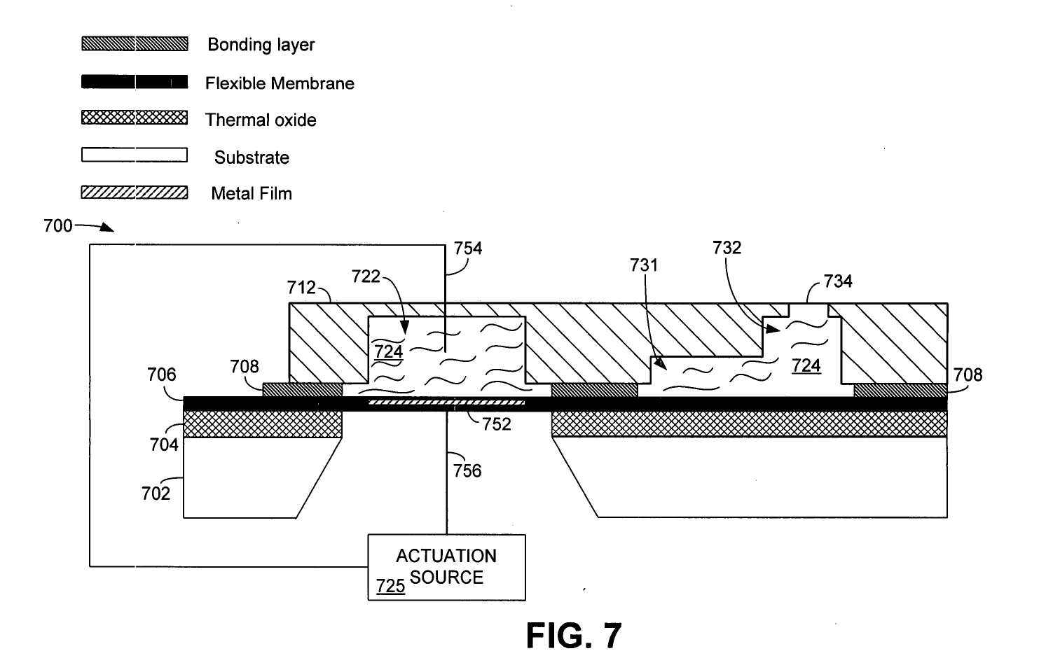

FIG. 7 is a detailed schematic diagram illustrating the cross-sectional view of an alternative embodiment of the membrane switch element of FIGS. 4A and 4B. The membrane switch element 700 is similar to the membrane switch element 400. However, the membrane switch element 700 is electrostatically activated. A silicon substrate 702 is provided over which a thermal oxide layer 704 is formed. However, other materials may be used for the substrate 702. The layer 704 is similar to the layer 404 described above.

A flexible membrane 706 formed from a material having a low modulus of elasticity is located over the thermal oxide layer 704. The flexible membrane 706 is similar to the flexible membrane 406 described above. However, the flexible membrane 706 can be formed using membrane portions 706a and 706b, which sandwich a metal film. The metal film forms a first electrode 752. In this embodiment, the electrode 752 is located in the vicinity of the microfluidic cavity 722.

Portions of the substrate 702 and the thermal oxide 704 are removed under the membrane 706. A layer of bonding material 708 is applied over the membrane 706 to bond a cap 712 in place over the membrane 706. The cap 712 and the surface of the membrane 706 form the microfluidic cavity 722 that contains a liquid 724. The liquid 724 can be any liquid that can be electrically coupled and that can provide an electrical connection to ground. For example, a liquid can be modified to exhibit ionic conductivity by adding salt. In the case of liquid chromatography, the liquid 724 can be a mixture of salt water and a solvent, such as acetonitrile. In this example, the flow of the liquid 724 is into or out of the plane of the page.

In this embodiment, an actuation source 725 comprises, for example, an electrostatic actuator. In one embodiment, the actuation source can be a voltage source. A second electrode 754 is located in the microfluidic cavity 722 in contact with the liquid 724. The first electrode 752 is connected to the activation source 725 via connection 756. The second electrode 754 is also connected to the actuation source 725. A control circuit is omitted from FIG. 7 for simplicity. However, a control circuit, such as the feedback electronics 116 (FIG. 1) may control the operation of the actuation source 725. The actuation source 725 electrostatically actuates the membrane 706 be creating an electric field between the first electrode 752 and the second electrode 754. The electric field causes the membrane 706 to deflect into the microfluidic cavity 722 and impede the flow of the fluid 724.

The cap 712 and the membrane 706 also define a shallow channel 731 and a deep channel 732. The shallow channel 731 and the deep channel 732 also contain fluid 724. The shallow channel 731 provides a higher impedance fluid connection, and the deep channel 732 provides a lower impedance fluid connection. The through etch 734 is for the fluidic input and output to and from the switch element 700.

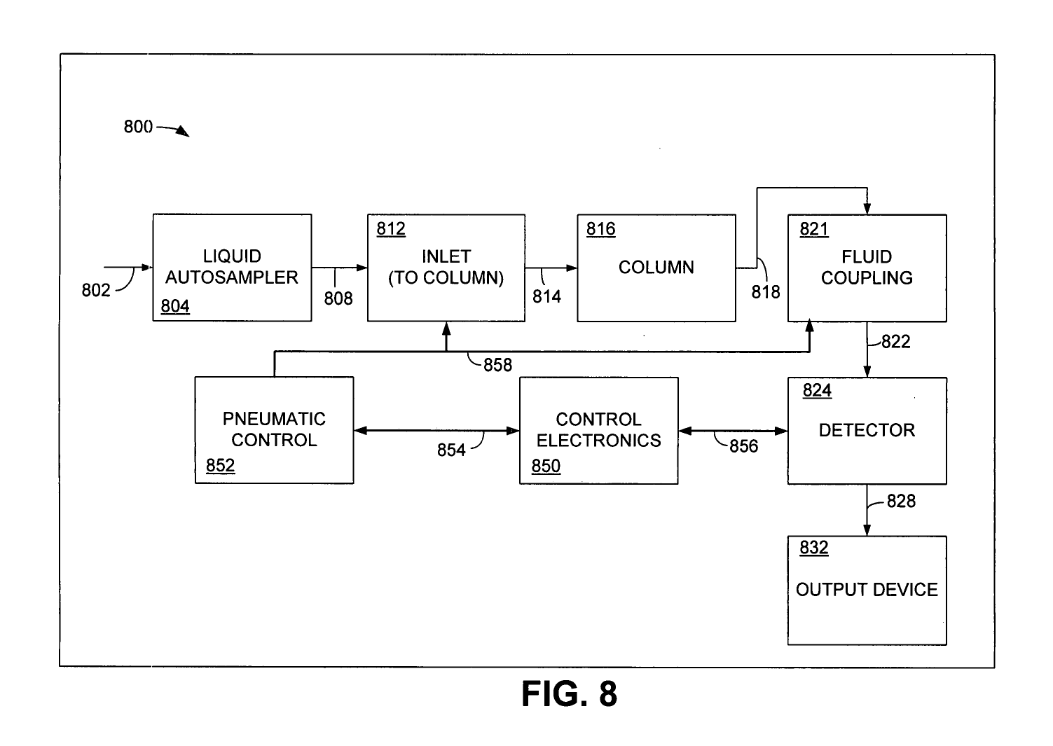

FIG. 8 is a block diagram illustrating a simplified analytical device 800, which is an exemplary device in which one or more membrane switch elements may be implemented. In this example, the analytical device 800 is a liquid chromatograph. For simplicity, only the basic elements of a liquid chromatograph are illustrated in FIG. 8. The membrane switch element described herein may be implemented to control fluid flow in any microfluidic circuit.

The liquid chromatograph 800 includes a means of introducing a sample. A sample can be introduced as a liquid via, for example, a liquid autosampler 804. The liquid autosampler 804 introduces a liquid sample into an inlet 812. The inlet 812 is typically connected to a chromatographic column 816. The sample is transferred from the inlet 812 to a chromatographic column 816 via connection 814. The output of the chromatographic column 816 is coupled via connection 818 to a fluid coupling 821. The fluid coupling 821 can be used to couple a capillary tube, such as a chromatographic column 816, or any other tubing to another element within the analytical device 800. In FIG. 8, the fluid coupling 821 is used to couple the chromatographic column 816 to a detector 824. The detector 824 is coupled to an output device 832 via connection 828. The output device 832 can be, for example, a printer or other device that provides the results of the analysis.

A control electronics module 850 is coupled to the detector 824 via connection 856 and to a pneumatic control module 852 via connection 854. The connections 854 and 856 can be, for example, bi-directional serial communication links that enable multiplexed communication between the control electronics module 850 and the peripheral modules to which it is coupled. The pneumatic control module 852 is coupled to the inlet 812 and to the fluid coupling 821 via connection 858. The pneumatic control module 852 controls the operation of the various fluid paths in the analytical device 800. In an embodiment in accordance with the invention, one or more membrane switch elements are located at the inlet 812 and controlled by the pneumatic control module 852. For example, the pneumatic control module 852 provides the actuation force to the one or more membrane switch elements to control the flow of liquid through the column 816. The control electronics 850 includes the feedback electronics 116 (FIG. 1) to provide pressure and flow monitoring of the column 816.

This disclosure describes embodiments in accordance with the invention in detail. However, it is to be understood that the invention defined by the appended claims is not limited to the precise embodiments described.

What is claimed is:

1. A system for controlling fluid flow in a microfluidic circuit located in a liquid chromatograph, comprising:
at least one microfluidic channel; and
a flexible membrane adjacent the at least one microfluidic channel, wherein when actuated, the flexible membrane deflects into the microfluidic channel, thus impeding fluid flow in the microfluidic channel.

2. The system of claim 1, further comprising a plurality of flexible membranes arranged in series adjacent the microfluidic channel.

3. The system of claim 2, in which each of the flexible membranes has a different modulus of elasticity.

4. The system of claim 3, further comprising a first group of flexible membranes having a first modulus of elasticity located in series with a second group of flexible membranes having a second modulus of elasticity.

5. The system of claim 1, further comprising a pressure actuator configured to actuate the flexible membrane.

6. The system of claim 1, further comprising an electrostatic actuator configured to actuate the flexible membrane.

7. The system of claim 1, in which the microfluidic channel and the flexible membrane are part of a planar structure.

8. A method for controlling fluid flow in a microfluidic circuit located in a liquid chromatograph, comprising:
providing at least one microfluidic channel;
providing a flexible membrane adjacent the at least one microfluidic channel; and
actuating the flexible membrane to deflect the flexible membrane into the microfluidic channel, thus impeding fluid flow in the microfluidic channel.

9. The method of claim 8, further comprising providing a plurality of flexible membranes arranged in series adjacent the microfluidic channel.

10. The method of claim 9, further comprising providing each of the flexible membranes with a different modulus of elasticity.

11. The method of claim 10, further comprising providing a first group of flexible membranes having a first modulus of elasticity located in series with a second group of flexible membranes having a second modulus of elasticity.

12. The method of claim 8, further comprising actuating the flexible membrane using a pressure actuator.

13. The method of claim 8, further comprising actuating the flexible membrane using an electrostatic actuator.

14. The method of claim 8, further comprising providing the microfluidic channel and the flexible membrane as a planar structure.

15. A system for controlling fluid flow in a microfluidic circuit located in a liquid chromatograph, comprising:
at least one microfluidic channel;
a flexible membrane adjacent the at least one microfluidic channel; and
a pressure source configured to actuate the flexible membrane, wherein when actuated, the flexible membrane deflects into the microfluidic channel, thus impeding fluid flow in the microfluidic channel.

16. The system of claim 15, further comprising a plurality of flexible membranes arranged in series adjacent the microfluidic channel.

17. The system of claim 16, in which each of the flexible membranes has a different modulus of elasticity.

18. The system of claim 17, further comprising a first group of flexible membranes having a first modulus of elasticity located in series with a second group of flexible membranes having a second modulus of elasticity.

19. The system of claim 15, in which the microfluidic channel and the flexible membrane are part of a planar structure.

20. The system of claim 15, further comprising feedback electronics, the feedback electronics configured to monitor fluid flow in the microfluidic channel and control the fluid flow by selectively activating the flexible membrane.
